(19) United States
(12) Patent Application Publication
(10) Pub. No.: US 2023/0207816 A1
(43) Pub. Date: Jun. 29, 2023

(54) COMPOSITE BINDER FOR SELF-EXTINGUISHING LITHIUM ION BATTERY AND LITHIUM ION BATTERY

(71) Applicant: Shenzhen University, Shenzhen (CN)

(72) Inventors: Jinlong Yang, Shenzhen (CN); Yihang Gan, Shenzhen (CN); Zexin Zou, Shenzhen (CN); Chuye Pan, Shenzhen (CN); Lei Liu, Shenzhen (CN); Shucong Zhou, Shenzhen (CN); Huilin Yang, Shenzhen (CN); Runji Chen, Shenzhen (CN); Yaowei Mai, Shenzhen (CN); Zejian Du, Shenzhen (CN)

(73) Assignee: Shenzhen University, Shenzhen, GD (CN)

(21) Appl. No.: 18/118,139

(22) Filed: Mar. 7, 2023

(30) Foreign Application Priority Data
Jun. 14, 2022 (CN) 202210673406.0

(51) Int. Cl. H01M 4/62; H01M 4/04; H01M 10/0525; H01M 50/417; H01M 50/434; H01M 50/457

(52) U.S. Cl. CPC H01M 4/622; H01M 4/0471; H01M 10/0525; H01M 4/625; H01M 4/0404; H01M 50/417; H01M 50/434; H01M 50/457; H01M 2300/0028

(57) ABSTRACT

The present disclosure discloses a composite binder for a self-extinguishing lithium ion battery and a lithium ion battery. The composite binder is obtained by adding ammonium polyphosphate and polyacrylic acid into a solvent to prepare a mixed solution and then carrying out thermal treatment on the above mixed solution. The present disclosure combines the flame retardancy of ammonium polyphosphate with the feature of polyacrylic acid to inhibit volume expansion, so that a stable solid electrolyte interface (SEI) film is formed on the surface of the prepared lithium ion battery during the cycling, thereby significantly promoting the electrochemical performance of the lithium ion battery while improving the flame retardancy of the battery; besides, ammonium polyphosphate and polyacrylic acid can be crosslinked after being heated due to the interaction of hydrogen bonds to form a three-dimensional network structure, which significantly improves the structural stability of the battery.

### TECHNICAL FIELD

The present disclosure belongs to the technical fields of material preparation and electrochemical energy conversion, and particularly relates to a composite binder for a self-extinguishing lithium ion battery and a lithium ion battery.

### BACKGROUND

Nowadays, with the increase of population, the shortage, pollution and other problems of the traditional energy are increasingly aggravated. Clean, renewable and green energy attracts more and more attention, however the use, transformation and storage of green energy have become the bottleneck of development. Lithium ion batteries have attracted much attention in the field of renewable energy because of their high energy density and energy efficiency. However, the frequent safety problems of the lithium ion battery cause serious harm. Therefore, it is necessary to modify the lithium ion battery to improve its safety performance without affecting the battery performance. The green low-cost flame-retardant ammonium polyphosphate and water-based binder polyacrylic acid with excellent mechanical properties are compounded and then added to all parts of the lithium ion battery, which is conducive to improve the stability and safety of the lithium ion battery and is expected to become a solution for the safety problems of the lithium ion battery.

### SUMMARY

In order to solve the defects in the prior art, the objective of the present disclosure is to provide a composite binder for a self-extinguishing lithium ion battery and the lithium ion battery. The composite binder for the self-extinguishing lithium ion battery makes the prepared lithium ion battery have not only good flame retardancy, but also excellent electrochemical performance and structural stability.

In order to achieve the above objective, the present disclosure adopts the following technical solutions:

Provided is a composite binder for a self-extinguishing lithium ion battery, wherein the composite binder is obtained by adding ammonium polyphosphate and polyacrylic acid into a solvent to prepare a mixed solution and then carrying out thermal treatment on the mixed solution.

Preferably, the polymerization degree of the ammonium polyphosphate is 20-1500.

Preferably, the average molecular weight of the polyacrylic acid is 450 K-3000 K.

Preferably, a mass ratio of the ammonium polyphosphate to the polyacrylic acid is 1:10-10:1.

Preferably, the solvent is one or more of N-methylpyrrolidone, deionized water and N,N-dimethylformamide.

Preferably, a mass fraction of a solute in the composite binder is 2-4%.

Preferably, the temperature of the thermal treatment is 70-90° C.

More preferably, the temperature of the thermal treatment is 80° C.

Another objective of the present disclosure is to provide a self-extinguishing lithium ion battery, comprising a cathode piece, an anode piece, a diaphragm located between the cathode piece and the anode piece and an electrolyte, wherein the cathode piece, the anode piece and the diaphragm contain the above composite binder.

Preferably, a method for preparing the cathode piece or the anode piece comprises: fully mixing and grinding anode material powders or cathode material powders and conductive carbon black, then adding the composite binder, and evenly stirring to prepare electrode slurry; and coating the electrode slurry onto a current collector, drying to remove water, and then cutting to obtain the cathode pole piece or the anode pole piece.

Preferably, the diaphragm is one or more of a polypropylene (PP) single-layer diaphragm, a ceramic coating diaphragm and a PP-polyethylene (PE)-PP three-layer diaphragm.

Preferably, the electrolyte is one or more of ethylene carbonate, dimethyl carbonate, methyl ethyl carbonate and lithium hexafluorophosphate.

Meanwhile, the present disclosure claims use of the prepared composite binder in a lithium ion battery.

Compared with the prior art, the present disclosure has the beneficial effects:

1. The composite binder for the self-extinguishing lithium ion battery provided by the present disclosure adopts the composite binder and utilizes a strong dehydrating agent generated after ammonium polyphosphate is heated to promote the dehydration of the surface of an organic matter to generate carbides, and the generated non-volatile phosphorus oxide and polyphosphoric acid cover the surface of a substrate, thereby isolating combustibles from a combustion improver so as to achieve the purpose of flame retardancy; meanwhile, the characteristic of polyphosphoric acid to inhibit the expansion of the volume can be utilized to combine polyphosphoric acid with ammonium polyphosphate, so as to take a synergistic effect so that a stable SEI film is formed on the surfaces of a cathode and an anode of a lithium ion battery during the cycling, thereby further improving the flame retardancy and safety of the lithium ion battery.

2. The composite binder for the self-extinguishing lithium ion battery provided by the present disclosure further improves the coulomb efficiency and cycle stability of the lithium ion battery to a certain extent due to the formation of the SEI film during the cycling of the battery.

3. In the composite binder for the self-extinguishing lithium ion battery provided by the present disclosure, ammonium polyphosphate and polyacrylic acid can be crosslinked after being heated due to the interaction of hydrogen bonds so as to form a three-dimensional network structure, which improves the mechanical properties of the pole piece and significantly improves the structural stability of the lithium ion battery.

4. Compared with the flame retardant and binder used in the process of preparing the existing lithium ion battery, the composite binder for the self-extinguishing lithium ion battery provided by the present disclosure is lower in cost, and more green and environmental-friendly.

### BRIEF DESCRIPTION OF THE DRAWINGS

FIG. 1 is a scanning electron microscopy (SEM) image of an SEI film formed after 500 cycles of an electrode of a lithium ion battery after an active material in example 1 is mixed with a composite binder;

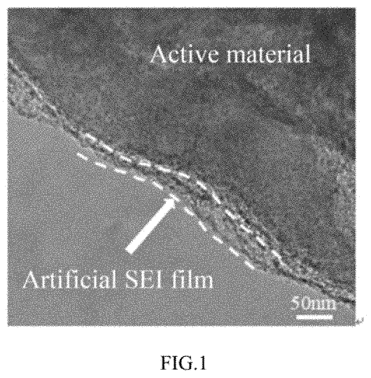

FIG. 2 is a rate capability comparison graph of a half battery when the traditional polyvinylidene fluoride (PVDF) binder and the composite binder of the present disclosure are respectively used in a graphite anode material;

FIG. 3 is a capacity and cycle performance comparison graph of a half battery when the traditional PVDF binder and the composite binder of the present disclosure are respectively used in a graphite anode material;

FIG. 4 is a test rate capability result graph of a half battery composed of a lithium iron phosphate cathode, a ceramic diaphragm coated with a composite binder on the surface and a lithium piece;

FIG. 5 is a test cycle and capacity performance result graph of a half battery composed of a lithium iron phosphate cathode, a ceramic diaphragm coated with a composite binder on the surface and a lithium piece;

FIG. 6 is a test rate capability result graph of a whole battery composed of a lithium iron phosphate cathode, a ceramic diaphragm coated with a composite binder on the surface and a graphite anode;

FIG. 7 is test cycle and capacity performance result graph of a half battery composed of a lithium iron phosphate cathode, a ceramic diaphragm coated with a composite binder on the surface and a graphite anode;

FIG. 8 is a comparison graph of self-extinguishing effects of a bag type battery in which an electrolyte is dropwise added, wherein the upper part shows use of a traditional diaphragm and a binder, and the lower part shows use of a ceramic diaphragm and a composite binder.

### DETAILED DESCRIPTION OF THE EMBODIMENTS

In order to make the purpose, technical solution and advantages of the present disclosure more clear, the present disclosure will be further described in detail in combination with embodiments. Of course, the specific embodiments described herein are only for explaining the present disclosure but not limiting the present disclosure.

Although the steps in the present disclosure are ranked with reference numbers, the reference numbers are not used for limiting the sequence of the steps, unless the sequence of the steps is clearly stated or the execution of a step requires other steps as a basis, the relative sequence of the steps can be adjusted. It is understood that the term “and/or” used herein involves and covers any and all possible combinations of one or more of the associated listed items.

Unless otherwise specified, chemical reagents and materials used in the present disclosure are commercially available or synthesized from raw materials purchased on the market.

### EXAMPLE 1

A preparation method of a composite binder for a self-extinguishing lithium ion battery comprises:

Ammonium polyphosphate and polyacrylic acid were mixed in a mass ratio of 5:10, and then deionized water was added, so as to prepare 30 mL of mixed solution, and then the mixed solution was subjected to thermal treatment at 80° C. to obtain a composite binder with 3 wt % solute;

wherein, the polymerization degree of ammonium polyphosphate was 40, and the average molecular weight of polyacrylic acid was 450 K;

A self-extinguishing lithium ion battery comprises a cathode piece, an anode piece, a diaphragm located between the cathode piece and the anode piece and an electrolyte. The cathode piece, the anode piece and the diaphragm contain the above composite binder. The preparation method of the cathode piece and the anode piece in the self-extinguishing lithium ion battery comprises:

(1) Preparation of anode piece: graphite anode powders and acetylene black were grounded and mixed for 45 min, then the above composite binder was added, and the above materials were stirred for 1 h to prepare electrode slurry, wherein a mass ratio of the graphite anode powders to the acetylene black to the composite binder was 8:1:1; the electrode slurry was coated onto the rough surface of copper foil with a coating thickness of 15 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 80° C. for 24 h to obtain a dried anode piece;

(2) Preparation of cathode piece: lithium iron phosphate powders and acetylene black were grounded and mixed for 45 min, then the above composite binder was added, and the above materials were stirred for 1 h to prepare electrode slurry, wherein a mass ratio of the lithium iron phosphate powders to the acetylene black to the composite binder was 8:1:1; the electrode slurry was coated onto the rough surface of copper foil with a coating thickness of 10 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 100° C. for 24 h to obtain a dried cathode piece.

### EXAMPLE 2

A preparation method of a composite binder for a self-extinguishing lithium ion battery comprises:

Ammonium polyphosphate and polyacrylic acid were mixed in a mass ratio of 6:9, and then N-methylpyrrolidone was added, so as to prepare 30 mL of mixed solution, and then the mixed solution was subjected to thermal treatment at 80° C. to obtain a composite binder with 3 wt % solute;

wherein, the polymerization degree of ammonium polyphosphate was 500, and the average molecular weight of polyacrylic acid was 1000 K;

A self-extinguishing lithium ion battery comprises a cathode piece, an anode piece, a diaphragm located between the cathode piece and the anode piece and an electrolyte. The cathode piece, the anode piece and the diaphragm contain the above composite binder. The preparation method of the cathode piece and the anode piece in the self-extinguishing lithium ion battery comprises:

(1) Preparation of anode piece: silicon carbon anode powders and acetylene black were grounded and mixed for 45 min, then the above composite binder was added, and the above materials were stirred for 1 h to prepare electrode slurry, wherein a mass ratio of the silicon carbon anode powders to the acetylene black to the composite binder was 8:1:1; the electrode slurry was coated onto the rough surface of copper foil with a coating thickness of 15 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 80° C. for 24 h to obtain a dried anode piece;

(2) Preparation of cathode piece: lithium manganate powders and acetylene black were grounded and mixed for 45 min, then the above composite binder was added, and the above materials were stirred for 1 h to prepare electrode slurry, wherein a mass ratio of the lithium manganate powders to the acetylene black to the composite binder was 8:1:1; the electrode slurry was coated onto the rough surface of copper foil with a coating thickness of 10 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 100° C. for 24 h to obtain a dried cathode piece.

### EXAMPLE 3

A preparation method of a composite binder for a self-extinguishing lithium ion battery comprises:

Ammonium polyphosphate and polyacrylic acid were mixed in a mass ratio of 6:9, and then N-methylpyrrolidone was added, so as to prepare 30 mL of mixed solution, and then the mixed solution was subjected to thermal treatment at 80° C. to obtain a composite binder with 3 wt % solute;

wherein, the polymerization degree of ammonium polyphosphate was 1000, and the average molecular weight of polyacrylic acid was 2000 K;

A self-extinguishing lithium ion battery comprises a cathode piece, an anode piece, a diaphragm located between the cathode piece and the anode piece and an electrolyte. The cathode piece, the anode piece and the diaphragm contain the above composite binder. The preparation method of the cathode piece and the anode piece in the self-extinguishing lithium ion battery comprises:

(1) Preparation of anode piece: graphite anode powders and acetylene black were grounded and mixed for 45 min, then the above composite binder was added, and the above materials were stirred for 1 h to prepare electrode slurry, wherein a mass ratio of the graphite anode powders to the acetylene black to the composite binder was 8:1:1; the electrode slurry was coated onto the rough surface of copper foil with a coating thickness of 15 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 80° C. for 24 h to obtain a dried anode piece;

(2) Preparation of cathode piece: lithium manganate powders and acetylene black were grounded and mixed for 45 min, then the above composite binder was added, and the above materials were stirred for 1 h to prepare electrode slurry, wherein a mass ratio of the lithium manganate powders to the acetylene black to the composite binder was 8:1:1; the electrode slurry was coated onto the rough surface of copper foil with a coating thickness of 10 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 100° C. for 24 h to obtain a dried cathode piece.

### EXAMPLE 4

A preparation method of a composite binder for a self-extinguishing lithium ion battery comprises:

Ammonium polyphosphate and polyacrylic acid were mixed in a mass ratio of 5:10, and then deionized water was added, so as to prepare 30 mL of mixed solution, and then the mixed solution was subjected to thermal treatment at 80° C. to obtain a composite binder with 3 wt % solute;

wherein, the polymerization degree of ammonium polyphosphate was 1500, and the average molecular weight of polyacrylic acid was 3000 K;

A self-extinguishing lithium ion battery comprises a cathode piece, an anode piece, a diaphragm located between the cathode piece and the anode piece and an electrolyte. The cathode piece, the anode piece and the diaphragm contain the above composite binder. The preparation method of the cathode piece and the anode piece in the self-extinguishing lithium ion battery comprises:

(1) Preparation of anode piece: silicon carbon anode powders and acetylene black were grounded and mixed for 45 min, then the above composite binder was added, and the above materials were stirred for 1 h to prepare electrode slurry, wherein a mass ratio of the silicon carbon anode powders to the acetylene black to the composite binder was 8:1:1; the electrode slurry was coated onto the rough surface of copper foil with a coating thickness of 15 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 80° C. for 24 h to obtain a dried anode piece;

(2) Preparation of cathode piece: lithium iron phosphate powders and acetylene black were grounded and mixed for 45 min, then the above composite binder was added, and the above materials were stirred for 1 h to prepare electrode slurry, wherein a mass ratio of the lithium iron phosphate powders to the acetylene black to the composite binder was 8:1:1; the electrode slurry was coated onto the rough surface of copper foil with a coating thickness of 10 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 100° C. for 24 h to obtain a dried cathode piece.

### COMPARATIVE EXAMPLE

A self-extinguishing lithium ion battery comprises a cathode piece, an anode piece, a diaphragm located between the cathode piece and the anode piece and an electrolyte. The cathode piece, the anode piece and the diaphragm contain a PVDF binder. The preparation method of the cathode piece and the anode piece in the self-extinguishing lithium ion battery comprises:

(1) Preparation of anode piece: silicon carbon anode powders and acetylene black were grounded and mixed for 45 min, then the PVDF binder was added, and the above materials were stirred for 1 h to prepare electrode slurry, wherein a mass ratio of the silicon carbon anode powders to the acetylene black to the PVDF binder was 8:1:1; the electrode slurry was coated onto the rough surface of copper foil with a coating thickness of 15 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 80° C. for 24 h to obtain a dried anode piece;

(2) Preparation of cathode piece: lithium manganate powders and acetylene black were grounded and mixed for 45 min, then the PVDF binder was added, and the above materials were stirred for 1 h to prepare electrode slurry, wherein a mass ratio of the lithium manganate powders to the acetylene black to the PVDF binder was 8:1:1; the electrode slurry was coated onto the rough surface of copper foil with a coating thickness of 10 μm. After heating and sizing on a coating machine, the coated pole piece was fixed on a glass plate and dried in an air drying oven for 12 h; the dried pole piece was cut into a disc with a diameter of 10 mm and a 10 cm×1 cm strip, and the disc and the strip were dried in a vacuum drying oven at 100° C. for 24 h to obtain a dried cathode piece.

This comparative example differs from example 1 that the binder used in this comparative example is the PVDF binder.

Performance tests of products in examples 1-4 and comparative example are as follows:

(1) Cycle and Capacity Test

Test Method:

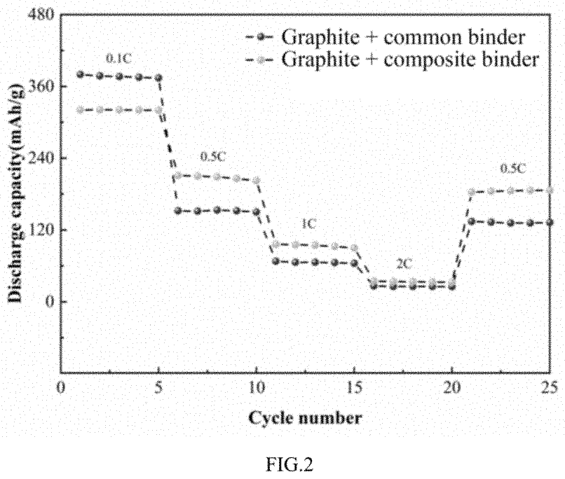

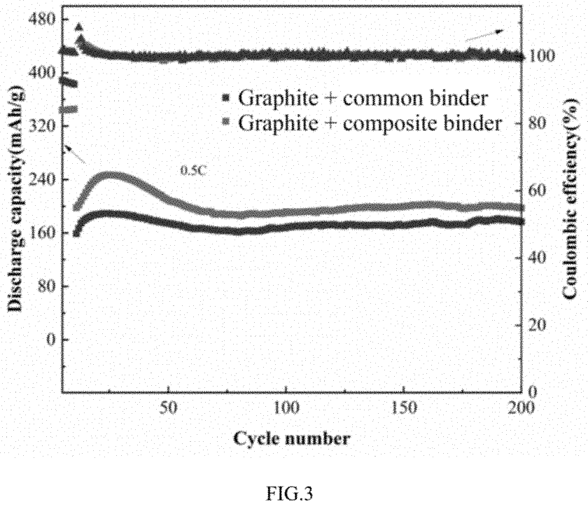

1) In an argon glove box, an anode shell, an elastic piece, a gasket, a lithium piece (d=14 mm) vinyl carbonate (35 μL), an ordinary diaphragm (PP-PE-PP) and vinyl carbonate (35 μL) as well as an anode piece, a gasket, and an electrode shell obtained in example 1 were sequentially assembled into an anode half battery. The half battery was subjected to rate capability test on Xinwei battery test equipment using 0.1 C, 0.5 C, 1 C and 2 C and a cut-off voltage of 0.01-2 V, and underwent cycle and capacity rest using 0.1 C and 0.5 C and a cut-off voltage of 0.01-2 V; a control sample was set, the difference of the control sample was that the anode piece used was the anode piece obtained in comparative example, and other conditions were completely the same as those in examples. The rate capability test results are shown in FIG. 2, and cycle and capacity test results are shown in FIG. 3.

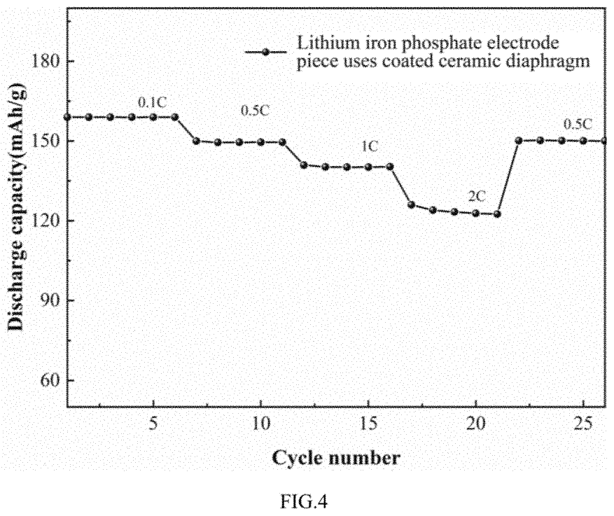

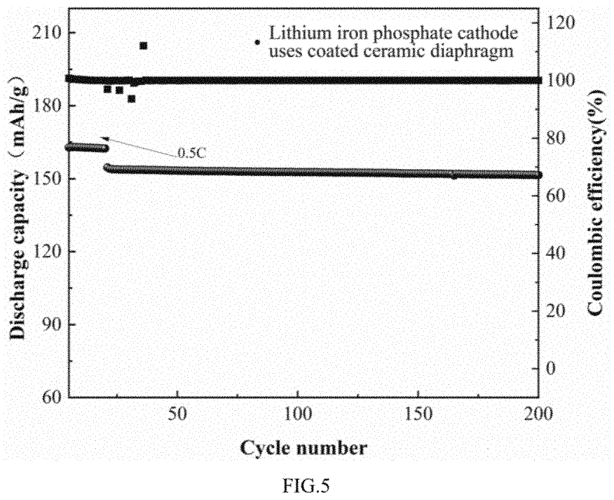

2) In the argon glove box, an anode shell, an elastic piece, a gasket, a lithium piece (d=14 mm) vinyl carbonate (35 μL), a coated ceramic diaphragm (the surface was coated with a composite binder with a thickness of 12 μm) and vinyl carbonate (35 μL) as well as a cathode piece, a gasket and an electrode shell obtained in example 1 were sequentially assembled into a cathode half battery. The half battery was subjected to rate capability test using 0.1 C, 0.5 C, 1 C and 2 C and a cut-off voltage of 2.5-4.2 V, and underwent cycle and capacity rest using 0.1 C and 0.5 C and a cut-off voltage of 2.5-4.2 V. The rate capability test results are shown in FIG. 4, and cycle and capacity test results are shown in FIG. 5.

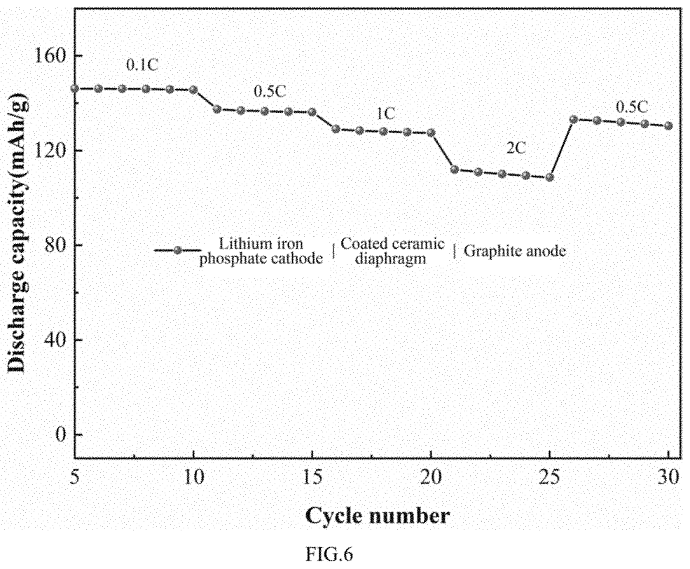

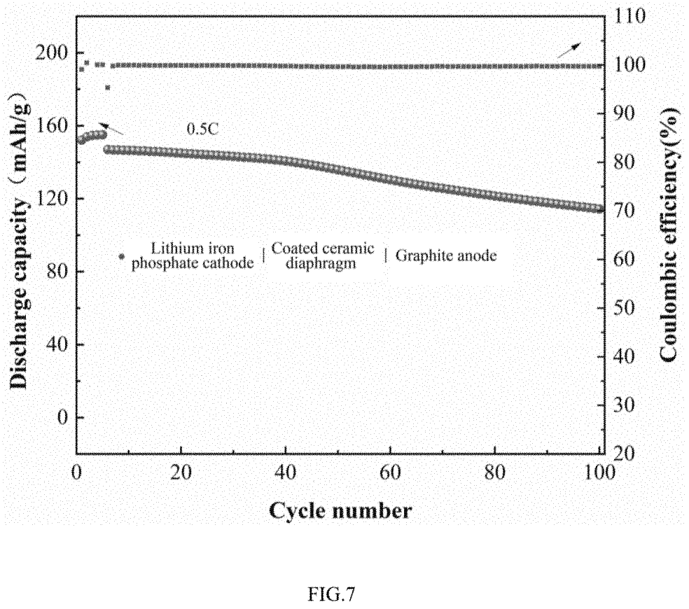

3) The surface of the ceramic diaphragm was coated with the composite binder with a thickness of 12 μm, dried and cut into a disc with a diameter of 16 mm; then, in the argon glove box, vinyl carbonate, the anode piece obtained in example 1 and the above ceramic diaphragm disc coated with the composite binder on the surface as well as the cathode piece, the elastic piece, the gasket and the cathode and anode shells obtained in example 1 were assembled into a button type whole battery according to N/P=1.15; the obtained button type whole battery was subjected to rate capability test on Xinwei battery test equipment using 0.1 C, 0.5 C, 1 C and 2 C and a cut-off voltage 2.4-4.1 V, and underwent cycle and capacity test using 0.1 C and 0.5 C and a cut-off voltage 2.4-4.1 V. Rate capability test results are shown in FIG. 6, and cycle and capacity test results are shown in FIG. 7.

Result Analysis:

It can be concluded from the cycle and capacity comparison test of the anode half battery that the cycle stability, capacity and rate capability of the anode half battery assembled by the anode pieces obtained by the present disclosure are better than those of the anode half battery assembled by the anode piece obtained in comparative example; after the cathode piece of the present disclosure and the diaphragm coated with the binder, as raw materials, are assembled into a battery, this cathode piece shows excellent cycle stability, indicating that the use of the binder of the present disclosure does not affect the capacity and rate capability of the half battery. Meanwhile, the button type battery formed by assembling the cathode and anode pieces obtained in the present disclosure ensures that the safety performance of the battery is improved without affecting the cycle stability, capacity and rate capability.

(2) Flame Retardancy Test

Test Method:

1) In a glove box, a strip-shaped anode piece obtained in example 1 was soaked into an electrolyte for 12 h. Then, the anode piece was transferred to a fume cupboard for ignition experiment. The ignition experiment starts from 0 s and ends when the flame is completely extinguished. The cycle is the ignition time. A SET value is obtained by dividing the mass of the electrolyte absorbed with the pole piece by the ignition time. The smaller the SET value, the higher the safety performance; in the control sample, the anode piece obtained in comparative example is used, and other conditions are the same.

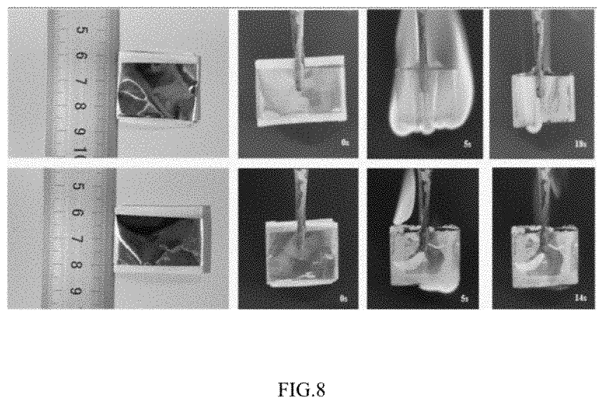

2) The strip-shaped cathode piece and strip-shaped anode piece obtained in example 1 as well as the ceramic diaphragm coated with the composite binder were cut into a proper length to be wound into a 2×2 cm bag type battery, and then the bag type battery was transferred to the fume cupboard, 600 μL of electrolyte was added for ignition experiment, the time from ignition to complete extinguishment of the flame is recorded as ignition time. A control sample was set for the same experiment. The difference of the control sample is that the pole piece used is the pole piece obtained in comparative example, the binder is the PVDF binder, and the diaphragm is a common PP-PE-PP diaphragm, and other conditions are the same. Then, after the whole battery was assembled, 600 μl of electrolyte was dropwise added for ignition treatment, and the ignition time was calculated. The self-extinguishing effect is shown in FIG. 8.

Results and Analysis:

1) in example 1, the SET value of the strip-shaped anode is 37.84 s/g, and the SET value of the control sample is 49.65 s/g; in example 2, the SET value of the strip-shaped anode is 35.24 s/g, and the SET value of the control sample is 51.58 s/g; in example 3, the SET value of the strip-shaped anode is 34.56 s/g, and the SET value of the control sample is 52.38 s/g; in example 4, the SET value of the strip-shaped anode is 32.33 s/g, and the SET value of the control sample is 53.45 s/g.

2) In example 1, the ignition time of the bag type battery is 14 s, and the ignition time of the control sample is 18 s; in example 2, the ignition time of the bag type battery is 13 s, and the ignition time of the control sample is 19 s; in example 3, the ignition time of the bag type battery is 15 s, and the ignition time of the control sample is 19 s; in example 4, the ignition time of the bag type battery is 14 s, and the ignition time of the control sample is 19 s.

In conclusion, the composite binder provided by the present disclosure has more excellent flame retardancy. Compared with the lithium ion battery in which the PVDF binder serves as the raw material, the flame retardancy of the lithium ion battery in which the composite binder obtained in the present disclosure serves as the raw material is improved by more than 20%, and has a good application prospect.

Those skilled in the art should understand that any improvements of the present disclosure, equivalent replacements of various product raw materials of the present disclosure and addition of auxiliary components, selection of specific manners are all included within the protective scope and disclosed scope of the present disclosure.

What is claimed is:

1. A composite binder for a self-extinguishing lithium ion battery, wherein the composite binder is obtained by adding ammonium polyphosphate and polyacrylic acid into a solvent to prepare a mixed solution and then carrying out thermal treatment on the above mixed solution.

2. The composite binder for the self-extinguishing lithium ion battery according to claim 1, wherein the polymerization degree of the ammonium polyphosphate is 20-1500.

3. The composite binder for the self-extinguishing lithium ion battery according to claim 1, wherein the average molecular weight of the polyacrylic acid is 450 K-3000 K.

4. The composite binder for the self-extinguishing lithium ion battery according to claim 1, wherein a mass ratio of the ammonium polyphosphate to the polyacrylic acid is 1:10-10:1.

5. The composite binder for the self-extinguishing lithium ion battery according to claim 1, wherein the solvent is one or more of N-methylpyrrolidone, deionized water and N,N-dimethylformamide.

6. The composite binder for the self-extinguishing lithium ion battery according to claim 1, wherein a mass fraction of a solute in the composite binder is 1-10%; the temperature of the thermal treatment is room temperature to 200° C.

7. A self-extinguishing lithium ion battery, comprising a cathode piece, an anode piece, a diaphragm located between the cathode piece and the anode piece and an electrolyte, wherein the cathode piece, the anode piece and the diaphragm contain the composite binder according to claim 1.

8. The self-extinguishing lithium ion battery according to claim 7, wherein a method for preparing the cathode piece or the anode piece comprises: fully mixing and grinding anode material powders or cathode material powders and conductive carbon black, then adding the composite binder, and evenly stirring to prepare electrode slurry; and coating the electrode slurry onto a current collector, drying to remove water, and then cutting to obtain the cathode pole piece or the anode pole piece.

9. The self-extinguishing lithium ion battery according to claim 7, wherein the diaphragm is one or more of a polypropylene (PP) single-layer diaphragm, a ceramic coating diaphragm and a PP-polyethylene (PE)-PP three-layer diaphragm; the electrolyte is one or more of ethylene carbonate, dimethyl carbonate, methyl ethyl carbonate and lithium hexafluorophosphate.

10. A use of the composite binder according to claim 1 in a lithium ion battery.
